(19) United States
(12) Patent Application Publication
(10) Pub. No.: US 2020/0367472 A1
(43) Pub. Date: Nov. 26, 2020

(54) PET GARMENT

(71) Applicant: Kristine Zarras, Toronto (CA)

(72) Inventor: Kristine Zarras, Toronto (CA)

(21) Appl. No.: 16/418,941

(22) Filed: May 21, 2019

(51) Int. Cl. A01K 13/00

(52) U.S. Cl. CPC A01K 13/006

(57) ABSTRACT

A pet garment system including a garment having a warm, waterproof body-section that substantially covers a canine-body including a hood, a plurality of leg sections, a plurality of removeable or attached boots, a closure-section, and a built-in harness. The plurality of leg sections include an elastic bungee-like action on the inside stitching allowing room to expand up and down to accommodate various heights of dogs. The garment provides waterproof and thermal protection against weather conditions.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of apparel and more specifically relates to pet apparel.

### 2. DESCRIPTION OF RELATED ART

Many people who own dogs live in geographical regions that experience long, cold winters where daytime high temperatures often stay well below freezing for weeks or months at a time. Despite such freezing temperatures the dogs must be allowed outdoors during the day. This presents significant problems, particularly when the ground is covered in ice, snow or slush, because the dog's pads get very cold, or experience pain from salt on the ground. Dog owners are currently struggling to get individual boots on each paw, plus place a jacket on their dog that provides minimal body protection. These boots often fall off and get lost in the snow, leaving the dog unprotected and the owner frustrated. Both jackets and boots are difficult to put on and take off of dogs of any size. A suitable solution is desired.

U.S. Pub. No. 2007/0193532 to Michael Shelton relates to canine apparel. The described canine apparel includes an article of apparel that can relatively easily enclose the body of a dog to retain undesirable debris located on or about the body of the animal. Thereby, dander, mud, dirt, water and other materials commonly found on and around a dog's body may be retained within the article of apparel keeping a vehicle, house, and other similar locations visited by the dog relatively clean. The apparel is made of a lightweight, washable, durable material that is preferably breathable.

### BRIEF SUMMARY OF THE INVENTION

In view of the foregoing disadvantages inherent in the known apparel art, the present disclosure provides a novel pet garment. The general purpose of the present disclosure, which will be described subsequently in greater detail, is to provide a garment allowing dogs to go outside and be protected from weather conditions.

A pet garment is disclosed herein. The pet garment includes a garment having a body-section that substantially covers a canine-body including a removeable hood, a plurality of leg sections, a plurality of boots, a closure-section, and a built-in harness. The hood is configured to protect a head and neck of a canine. The plurality of leg sections are configured to cover each leg of the canine. The plurality of boots is configured to cover each foot of the canine. The plurality of boots may be fixedly or removably attached to the plurality of leg sections. The plurality of leg sections preferably include an elastic bungee-like action on the inside stitching allowing room to expand up and down to accommodate various heights of dogs. In the embodiment with removably attached boots, the plurality of boots may be connected to the plurality of leg sections via zipper fasteners or other suitable fastening means. The plurality of boots may be removed and fastened as needed. The closure-section comprises the fastener which is configured to secure the garment around the canine-body. The fastener includes an inner fabric flap to protect dog hair from getting caught within the fastener. The built-in harness includes a first-harness-attachment and a second-harness-attachment on the outside of the garment, while the rest of the built-in harness is hidden underneath the outer layer of fabric. The garment provides protection against weather conditions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pet garment, constructed and operative according to the teachings of the present disclosure.

FIG. 1 is a perspective view of the pet garment during an ‘in-use’ condition, according to an embodiment of the disclosure.

FIG. 2 is a perspective view of the pet garment of FIG. 1, according to an embodiment of the present disclosure.

FIG. 3 is a perspective view of the pet garment of FIG. 1, according to an embodiment of the present disclosure.

FIG. 4 is a perspective view of the pet garment of FIG. 1, according to an embodiment of the present disclosure.

FIG. 5 is a perspective view of the pet garment of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to apparel and more particularly to a pet garment as used to improve the protection of animals in cold weather while adding ease of use to an owner.

Generally, the invention provides a solution to weather conditions for dogs to wear outside. The device provides easy, full body protection for a dog from the cold, snow, salt on paws, and such. The device may be easily donned and removed. Reflective light strips may be included for night time safety. In certain embodiments, the boots of the garment may be removeably attached to the garment via zippers or other suitable fasteners. The boots should be made of a lightweight 100 percent waterproof material with a very thin grip layer on the bottom. The boots may include a thin flexible rubber-like material with a fleece (or the like) interior. The garment may comprise a removable hood with drawstrings in certain embodiments. The garment may be provided in a rain or snow version. The rain version may be waterproof and breathable without inner fleece. The product may be provided in a variety of sizes (XS-XL) to accommodate various sized dogs comfortably.

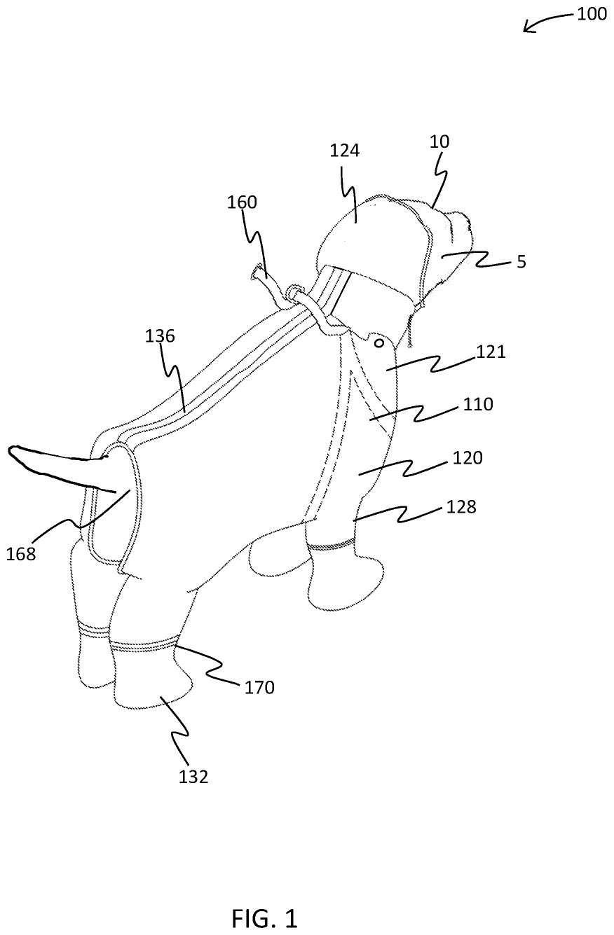

Referring now more specifically to the drawings by numerals of reference, there is shown in FIGS. 1-5, various views of a pet garment 100. FIG. 1 shows a pet garment 100 during an ‘in-use’ condition 150, according to an embodiment of the present disclosure. As illustrated, the pet garment 100 may include a garment 110 having a body-section 120 that substantially covers a canine-body 5 including a removeable hood 124, a plurality of leg sections 128, a plurality of boots 132, a closure-section 136, and a built-in harness 160. The garment 110 provides protection against weather conditions.

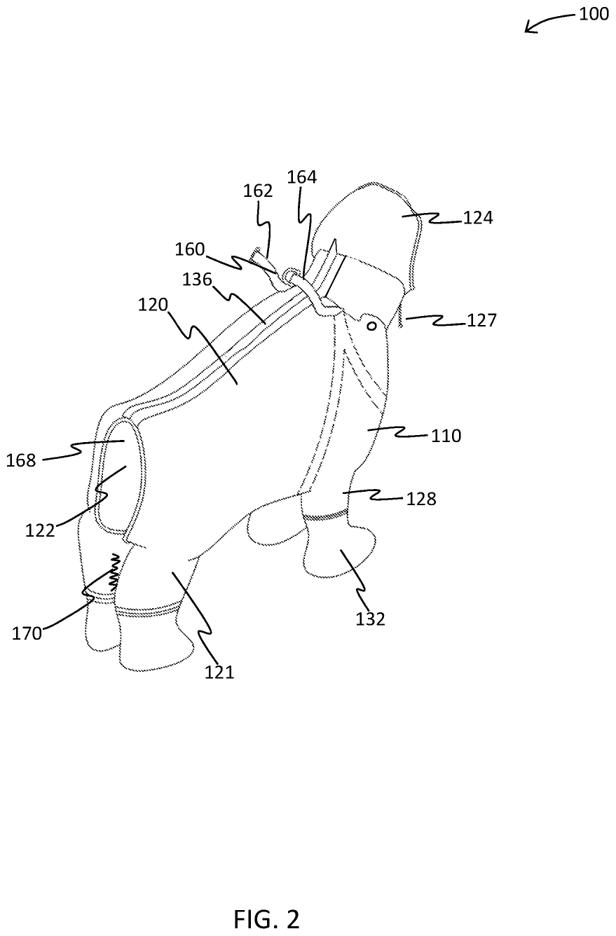

FIG. 2 shows a perspective view of the pet garment 100 of FIG. 1, according to an embodiment of the present disclosure. As above, the pet garment 100 may include the garment 110 having the body-section 120 that substantially covers the canine-body 5 including the hood 124, the plurality of leg sections 128, the plurality of boots 132, the closure-section 136, and the built-in harness 160. The hood 124 is configured to protect a head and neck of a canine 10. The plurality of leg sections 128 are configured to cover each leg of the canine 10. The plurality of boots 132 are configured to cover each foot of the canine 10. The plurality of boots 132 are fixedly attached to the plurality of leg sections 128. In other embodiments, the plurality of boots 132 are removably attached to the plurality of leg sections 128 via fasteners including but not limited to zipper fasteners, hook and loop fasteners, and the like.

The closure-section 136 comprises the fastener 138 which is configured to secure the garment 110 around the canine-body 5. The closure-section 136 comprises a flap underneath the fastener 138 for protection against pulling hair out. The closure-section 136 may be positioned on a top portion or bottom portion (underneath) of the garment 110. The built-in harness 160 includes a first-harness-attachment 162 and a second-harness-attachment 164. The plurality of leg sections 128 comprise expandable stitching to accommodate a height and a size of the canine 10. The expandable stitching 170 comprises elastic allowing the plurality of leg sections 128 to expand up and down to fit the canine 10.

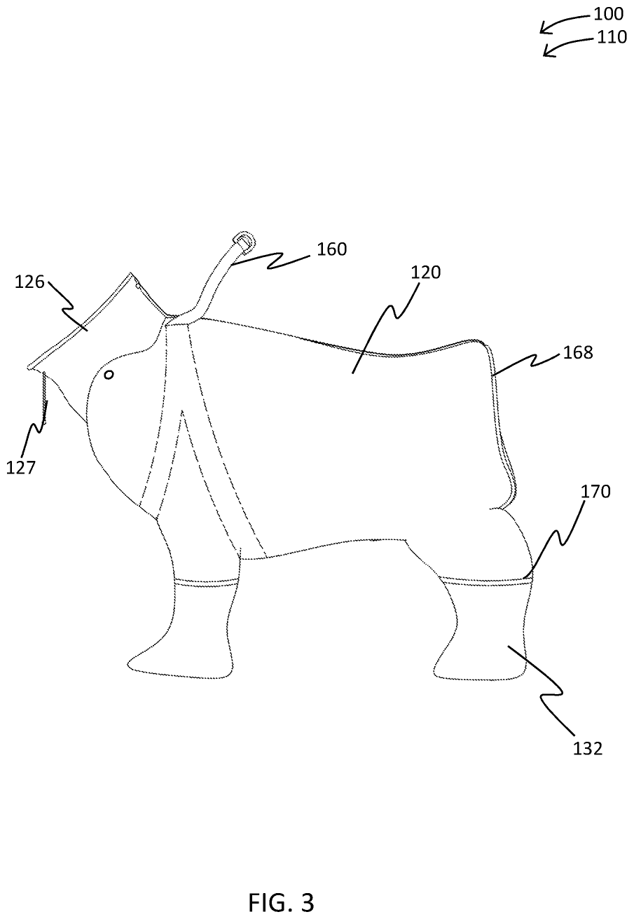

Referring now to FIG. 3 showing a perspective view of the pet garment 100 of FIG. 1, according to an embodiment of the present disclosure. As above, the pet garment 100 may include the garment 110 having the body-section 120 including the hood 124, the plurality of leg sections 128, the plurality of boots 132, the closure-section 136, and the built-in harness 160. The fastener 138 is preferably a hook and loop fastener having a male-fastener and a female-fastener, or a zipping fastener, that extends an entire length of the garment 110 from a neck opening to a tail opening for a full separation of both sides of the garment 110. Other suitable fasteners may be used. The plurality of boots 132 are non-removeable. In other embodiments, the plurality of boots 132 may be removeable. The plurality of boots 132 comprise waterproof fabric. The plurality of boots 132 comprise anti-slip gripping members 134. The body-section 120 further comprises an aperture 168 for a tail to extend therethrough. The body-section 120 further comprises an opening 166 for urination which may be combined with the aperture 168 as a single unit.

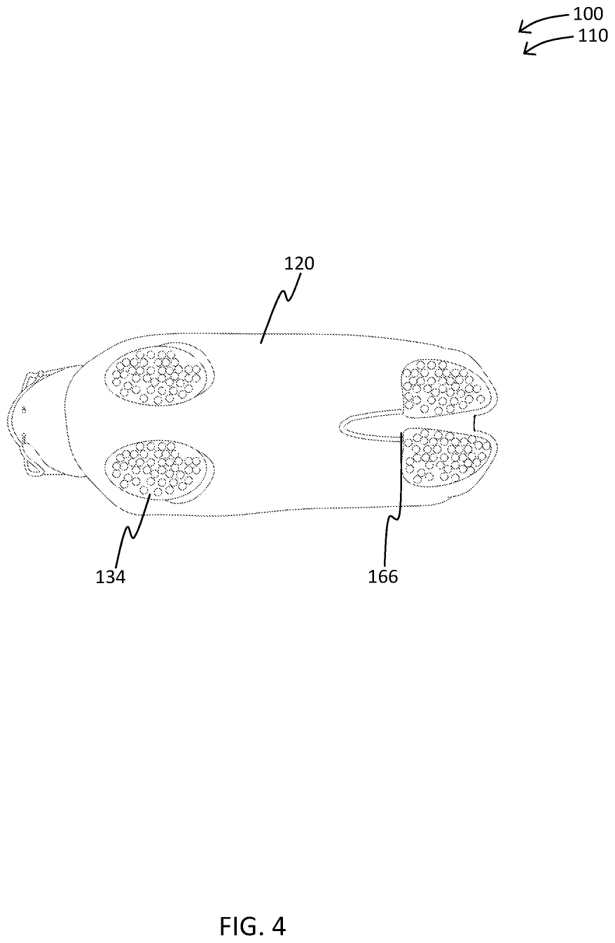

FIG. 4 shows a perspective view of the pet garment 100 of FIG. 1, according to an embodiment of the present disclosure. As above, the pet garment 100 may include the garment 110 for protecting a canine from weather condition. In a preferred embodiment, the hood 124 is detatchable. The hood 124 further comprises a plurality of snap-fasteners 126 for attaching and alternatively detatching the hood 124 from the body-section 120 at a corresponding snap-fastener 126. The hood 124 further includes drawstrings 127 allowing an owner to secure the hood 124 around a head of the canine 10. The hood 124 is configured to function as a scarf when in a bunched-up configuration.

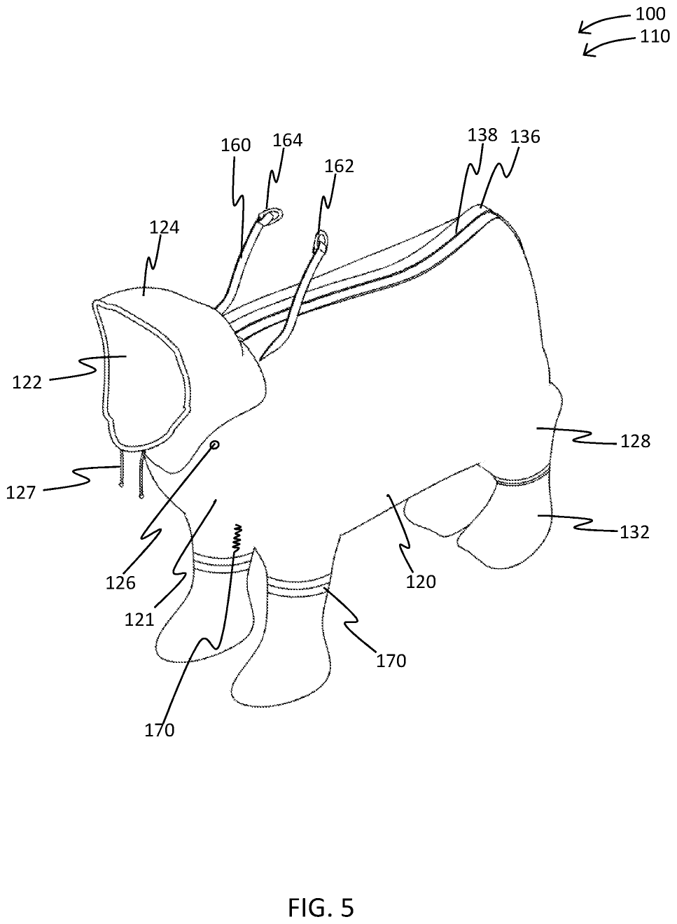

Referring now to FIG. 5 showing a perspective view of the pet garment 100 of FIG. 1, according to an embodiment of the present disclosure. As above, the pet garment 100 may include the body-section 120 including the hood 124, the plurality of leg sections 128, the plurality of boots 132, the closure-section 136, and the built-in harness 160. The built-in harness 160 is configured to attach to a leash. The built-in harness 160 is substantially positioned within an external-layer 121 and an internal-layer 122 of the body-section 120; the first-harness-attachment 162 and the second-harness-attachment 164 extending from the body-section 120. The first-harness-attachment 162 and the second-harness-attachment 164 each comprise a loop located at an end-portion of the first-harness-attachment 162 and the second-harness-attachment 164. The external-layer 121 of the pet garment 100 and body-section 120 is effectively waterproof. The internal-layer 122 of the body-section 120 comprises fleece or other suitable material for providing warmth and comfort.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet garment comprising:
a garment having;
a body-section that substantially covers a canine-body including;
a hood;
a plurality of leg sections;
a plurality of boots;
a closure-section; and
a built-in harness;
wherein said hood is configured to protect a head and neck of a canine;
wherein said plurality of leg sections are configured to cover each leg of said canine;
wherein said plurality of boots is configured to cover each foot of said canine;
wherein said closure-section comprises said fastener which is configured to secure said garment around said canine-body;
wherein said built-in harness includes a first-harness-attachment and a second-harness-attachment; and
wherein said plurality of leg sections comprise expandable stitching to accommodate a height and a size of said canine; and
wherein said garment provides protection against weather conditions.

2. The pet garment of claim 1, wherein said fastener is a hook and loop fastener having a male-fastener and a female-fastener.

3. The pet garment of claim 1, wherein said closure-section comprises a flap underneath said fastener for protection against pulling hair out.

4. The pet garment of claim 3, wherein said plurality of boots comprise waterproof fabric.

5. The pet garment of claim 1, wherein said hood is detatchable.

6. The pet garment of claim 5, wherein said hood further comprises a plurality of snap-fasteners for attaching and alternatively detatching said hood from said body-section at a corresponding snap-fastener.

7. The pet garment of claim 6, wherein said hood further comprises drawstrings.

8. The pet garment of claim 7, wherein said hood is configured to function as a scarf when in a bunched-up configuration.

9. The pet garment of claim 1, wherein said plurality of boots comprise anti-slip gripping members on a bottom portion.

10. The pet garment of claim 1, wherein said built-in harness is configured to attach to a leash.

11. The pet garment of claim 10, wherein said built-in harness is substantially positioned within an external-layer and an internal-layer of said body-section, said first-harness-attachment and said second-harness-attachment extending from said body-section.

12. The pet garment of claim 11, wherein said external-layer of said body-section is effectively waterproof.

13. The pet garment of claim 12, wherein said internal-layer of said body-section comprises fleece.

14. The pet garment of claim 1, wherein said body-section further comprises an aperture for a tail to extend therethrough.

15. The pet garment of claim 14, wherein said aperture further functions as an opening for urination.

16. The pet garment of claim 1, wherein said first-harness-attachment and said second-harness-attachment each comprise a loop located at an end-portion of said first-harness-attachment and said second-harness-attachment.

17. The pet garment of claim 1, wherein said expandable stitching comprises elastic allowing said plurality of leg sections to expand up and down to fit said canine.

18. The pet garment of claim 1, wherein said plurality of boots are removably attached to said plurality of leg sections.

19. The pet garment of claim 1, wherein said plurality of boots are fixedly attached to said plurality of leg sections.

20. A pet garment, the pet garment comprising:
a garment having;
a body-section that substantially covers a canine-body including;
a hood;
a plurality of leg sections;
a plurality of boots;
a closure-section; and
a built-in harness;
wherein said hood is configured to protect a head and neck of a canine;
wherein said hood is detatchable;
wherein said hood further comprises a snap-fastener for attaching and alternatively detatching said hood from said body-section at a corresponding snap-fastener;
wherein said hood further comprises drawstrings;
wherein said hood is configured to function as a scarf when in a bunched-up configuration;
wherein said plurality of leg sections are configured to cover each leg of said canine;
wherein said plurality of boots is configured to cover each foot of said canine;
wherein said plurality of boots are fixedly attached to said plurality of leg sections;
wherein said plurality of boots are non-removeable;
wherein said plurality of boots comprise waterproof fabric;
wherein said plurality of boots comprise anti-slip gripping members;
wherein said closure-section comprises said fastener which is configured to secure said garment around said canine-body;
wherein said built-in harness includes a first-harness-attachment and a second-harness-attachment;
wherein said built-in harness is configured to attach to a leash;
wherein said built-in harness is substantially positioned within an external-layer and an internal-layer of said body-section, said first-harness-attachment and said second-harness-attachment extending from said body-section;
wherein said first-harness-attachment and said second-harness-attachment each comprise a loop located at an end-portion of said first-harness-attachment and said second-harness-attachment;
wherein said external-layer of said body-section is effectively waterproof;
wherein said internal-layer of said body-section comprises fleece;
wherein said plurality of leg sections comprise expandable stitching to accommodate a height and a size of said canine;
wherein said expandable stitching comprises elastic allowing said plurality of leg sections to expand up and down to fit said canine;
wherein said garment provides protection against weather conditions;
wherein said fastener is a hook and loop fastener having a male-fastener and a female-fastener;
wherein said closure-section comprises a flap underneath said fastener for protection against pulling hair out;
wherein said body-section further comprises an aperture for a tail to extend therethrough; and
wherein said aperture further functions as an opening for urination.
